(19) United States
(12) Patent Application Publication
(10) Pub. No.: US 2008/0122978 A1
(43) Pub. Date: May 29, 2008

(54) SYSTEM AND METHOD FOR TV FRAME CAPTURE AND PRINTING

(76) Inventors: Ching-Shu Yen, Taipei County (TW); Chuan-Wen Chen, Tainan City (TW); Steve Wiyi Yang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/863,250

(22) Filed: Sep. 28, 2007

(30) Foreign Application Priority Data
Nov. 28, 2006 (TW) 095143880

(51) Int. Cl. H04N 5/44

(52) U.S. Cl. 348/559; 348/E05.107

(57) ABSTRACT

The present invention provides a system and method for TV frame capture and printing. The system includes a tuner, a processor, a memory, an image compression engine, a display unit, a connecting interface, an interface controller, and a printer. The tuner receives TV signals, and the processor processes the TV signal to generate a TV frame, which is stored in the memory. The image compression engine is controlled by the processor to read a target frame from the memory, and processes the target frame to generate an image file, which is also stored in the memory. The display unit displays the TV frame and image file. The interface controller controls the connecting interface, which is connected to the printer. The printer communicates with the processor through an image transmission standard to receive and print the image file.

### BACKGROUND OF INVENTION

1. Field of the Invention

The present invention relates to a system and method for image capture and printing, especially to a system and method for television (TV) frame capture and printing.

2. Description of the Prior Art

Sometimes audiences may want to note down the content of TV programs displayed on the screen when watching TV. These contents may be recipes, maps, concert information, and profiles of ball-game players. However, these contents usually do not show on the TV screen for a long time, meaning that only in the cases of either having a good memory or having a pen and paper at hand can a viewer note down these information.

At present, technology of directly capturing TV frames has been proposed. With such technology, the viewer can store the desired TV frames instantly and can avoid the inconvenience of not having pens and paper at hand. But if the viewer wants to print the TV frames out, a storage media such as a memory card would be needed to transfer the stored image to a computer such that the printer connected to the computer can print the data out. However, these procedures are trivial and inconvenient for users.

### SUMMARY OF INVENTION

It is therefore a primary objective of the claimed invention to provide a system and method for TV frame capture and printing, so as to utilize a TV apparatus to capture TV frames and control the printing of the TV frames.

According to an embodiment of the claimed invention, a system capable of capturing and printing a TV frame is disclosed. The system includes a tuner, a processor, a first memory, an image compression engine, a display unit, a first connecting interface, an interface controller, and a printer. The tuner is for receiving a TV signal. The processor coupled to the tuner is for processing the TV signal to generate the TV frame. The first memory coupled to the processor is for storing the TV frame. The image compression engine is coupled to the processor and the first memory. The processor controls the image compression engine to read a target frame from the first memory, and the image compression engine processes the target frame to generate an image file and stores the image file in the first memory. The display unit coupled to the processor is for displaying the TV frame and the image file. The interface controller coupled to the processor and the first connecting interface is for controlling the first connecting interface. The printer coupled to the first connecting interface is for communicating with the processor through an image transmission standard to receive and print the image file.

According to another embodiment of the claimed invention, a TV apparatus is disclosed. The TV apparatus comprises a tuner, a processor, a display unit, a Universal Serial Bus (USB) interface, and an interface controller. The tuner is for receiving a TV signal. The processor coupled to the tuner is for processing the TV signal to generate a TV frame. The display unit coupled to the processor is for displaying the TV frame. The USB interface supports the DC-001-2003 Digital Photo Solutions for Imaging Devices published by Camera and Imaging Products Association (CIPA). The interface controller coupled to the processor and the USB interface is for controlling the USB interface.

According to still another embodiment of the claimed invention, a method for capturing and printing a TV frame is disclosed. The method comprises: receiving a TV signal; processing the TV signal to generate the TV frame; storing the TV frame in a memory; processing a target frame read from the memory to generate an image file, and storing the image file in the memory; and transmitting the image file to a printer through an image transmission standard, so as to print the image file.

According to still another embodiment of the claimed invention, a control circuit of a TV capable of capturing and printing a TV frame is disclosed. The control circuit includes a processor, an image compression engine, and an interface controller. The processor is for processing a TV signal to generate the TV frame. The image compression engine is coupled to the processor, and the processor controls the image compression engine to transform the TV frame into an image file. The interface controller coupled to the processor is for transmitting the image file through a connecting interface supporting Digital Photo Solutions for Imaging Devices.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a system for TV frame capture and printing according to an embodiment of the claimed invention.

FIG. 2 is a diagram of a monitor of the display unit displaying new TV frames and the target frame at the same time by means of picture-out-picture.

FIG. 3 is a flow chart of the method for TV frame capture and printing according to an embodiment of the claimed invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

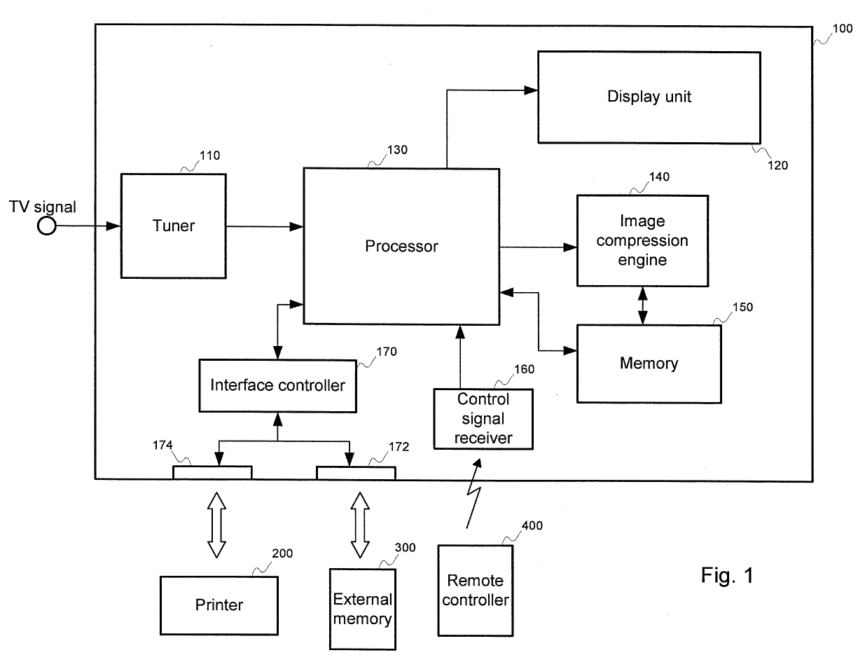

FIG. 1 shows a system for TV frame capture and printing according to an embodiment of the claimed invention. The system comprises a TV 100, a printer 200, an external memory 300, and a remote controller 400. The TV 100 comprises a tuner 110, a display unit 120, a processor 130, an image compression engine 140, a memory 150, a control signal receiver 160, an interface controller 170, and two connecting interfaces 172 and 174.

The tuner 110 is for receiving an analog or digital TV signal, and the TV signal is then transmitted to the processor 130 after down-conversion and frequency selection. If the TV signal is in an analog format, the TV signal will be converted into a digital format before it is transmitted to the processor 130. The processor 130 processes the TV signal with scaling, interpolation, brightness adjustment and etc., to generate a TV frame. The processor 130 transmits the TV frame to both the display unit 120 and the memory 150. The display unit 120 coupled to the processor 130 is for displaying the TV frame, and the memory 150 coupled to the processor 130 is for storing the TV frame. In a preferred embodiment, the display unit 120 is a liquid crystal display (LCD) module, and the memory 150 is a dynamic random access memory (DRAM). The TV frames are stored by the processor 130 in the manner that the processor 130 stores the TV frames in order in the memory 150.

The manipulation of the TV 100, such as changing channels and adjusting volume, can be carried out via the remote controller 400. In this embodiment, a user can also capture TV frames via the remote controller 400. A control signal which is a request for capturing TV frames is transmitted from the remote controller 400 to the control signal receiver 160. After receiving the control signal from the control signal receiver 160, the processor 130 not only continues processing the TV signal transmitted to the processor 130 at this time to generate a new TV frame, but also reads the frame corresponding to the selected target TV frame from the memory 150. The display unit 120 then displays the target TV frame sent from the processor 130. In practical, the processor 130 can cease displaying the new TV frames on the display unit 120, and the display unit 120 will only display the target frame; alternatively, the processor 130 transmits the new TV frames and the target frame at the same time to the display unit 120, and the display unit 120 displays the new TV frames and the target frame simultaneously by means of picture-out-picture (POP) or picture-in-picture (PIP).

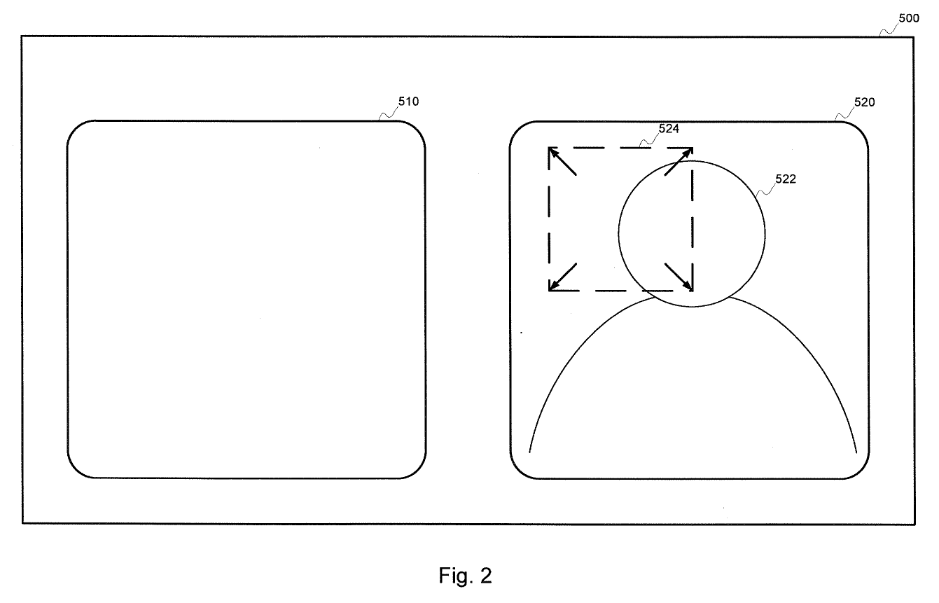

FIG. 2 shows a screen 500 of the display unit 120 displaying the new TV frames and the target frame at the same time by means of picture-out-picture according to an embodiment of the claimed invention. The screen 500 has two sub-windows 510 and 520 for respectively displaying the new TV frames in real time and the target frame 522. When the user determines to store the target frame 522, the processor 130 controls the image compression engine 140 to read the target frame 522 from the memory 150. The image compression engine 140 then compresses the target frame 522 to generate an image file and stores the image file in the memory 150; meanwhile the processor 130 keeps showing the image file (i.e., the target frame 522) in the sub-window 520. At this time, the user can edit the image file by using the remote controller 400 to call a selection area 524 on the sub-window 520, and also using the remote controller 400 to adjust the dimension and position of the selection area 524 to determine a processing region on the target frame 522. Once the processing region of the target frame 522 is determined, the processor 130 controls the image compression engine 140 to transform the image within the processing region into an output image file to be stored in the memory 150. Please note that editing the image file (i.e., the target frame 522) is an optional function depending on personal needs. In addition, the unedited image file or the edited output image file is of common formats, like JPG, GIF, TIFF, JPEG, BMP, and etc., and the image compression engine 140 is a JPEG engine according to a preferred embodiment.

The two connecting interfaces 172 and 174 communicate with the processor 130 under the control of the interface controller 170. The connecting interface 172 is for connecting with the external memory 300. The external memory 300 can be memory cards made of flash memory, such as a compact flash (CF) card and a secure digital (SD) card. The other connecting interface 174 for connecting with the printer 200 can be a universal serial bus (USB) interface. The unedited image file or the edited output image file generated by the image compression engine 140 and stored in the memory 150 is then read by the processor 130 and sent to the connecting interface 172 through the interface controller 170, so as to be stored in the external memory 300. Alternatively, the unedited image file or the edited output image file can be transmitted to the connecting interface 174 and then printed out by the printer 200. The detailed description of the interaction between the TV 100 and the printer 200 is described as follows. The communication between the TV 100 and the printer 200 must comply with a specific image transmission standard. More specifically, the image transmission standard is the DC-001-2003 digital photo solutions for imaging devices published by camera and imaging products association (CIPA), which is generally referred to as “PictBridge”.

According to the “PictBridge” standard, the printer 200 becomes a host and the TV 100 becomes a device. More precisely, the TV 100 becomes both a client for printing and a server for data access, whereas the printer 200 becomes both a serve for printing and a client for data access. During the printing process, the client for printing (the TV 100) sends commands to the server for printing (the printer 200) to start printing, and then the client for data access (the printer 200) makes a request to the server for data access (the TV 100) for the image file or the output image file. Accordingly, the image file or the output image file is read by the processor 130 from the memory 150, and sent to the printer 200 via the interface controller 170 and the connecting interface 174. The user can start the printer 200 through the TV 100, and the printer 200 can also send information, such as the current printing status and error messages, back to the TV 100 to inform the user.

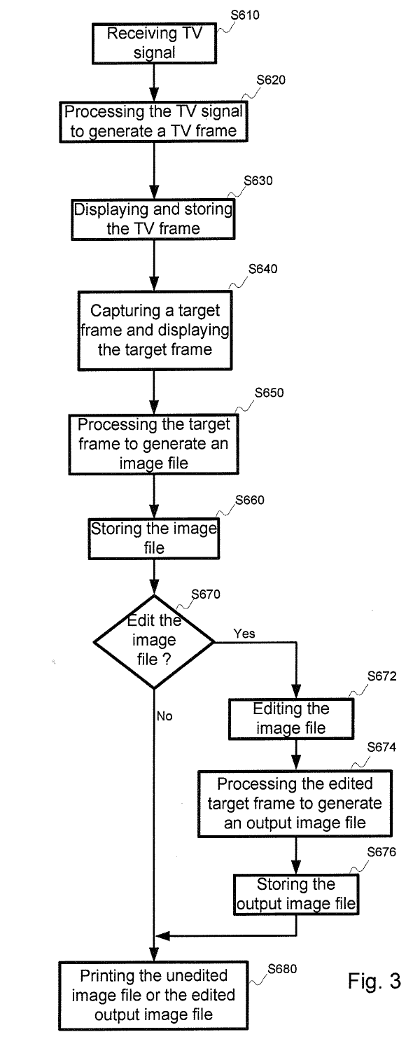

FIG. 3 illustrates a flow chart of the method for TV frame capture and printing according to an embodiment of the claimed invention. In the beginning, receiving an analog or digital TV signal (S610) through wired or wireless transmission.

Next, processing the TV signal to generate a TV frame (S620). The process includes down-converting, decoding, analog-to-digital conversion in case of the TV signal in an analog format, and image processing such as scaling, interpolation, brightness adjustment, hue adjustment, and motion enhancement. Then, displaying the TV frame on a monitor and storing the TV frame in a memory (S630).

Then, capturing a target frame and displaying the target frame on the monitor (S640). When watching TV programs, the user can decide which TV frame to be captured, and subsequently the selected target TV frame is displayed on the monitor. Moreover, the monitor can show the target frame alone or show both the target frame and the new TV frames at the same time by means of picture-out-picture (POP) or picture-in-picture (PIP).

Next, processing the target frame to generate an image file (S65). If the user confirms that the target frame is the desired TV frame to be captured, then the target frame is processed by image processes such as coding, compression, and etc.

Then, storing the image file in the memory (S660). The image file is of common formats, like JPG, GIF, TIFF, JPEG, BMP, and etc., and the image file is in JPEG format according to a preferred embodiment.

Next, determining whether to edit the image file (i.e., the target frame) (S670). If the user decide to edit the image file (i.e., the target frame), and the edit function such as cutting, rotating, and scaling is performed (S672). Then, processing the edited target frame to generate an output image file (S674). Next, storing the output image file in the memory (S676).

Then, outputting the unedited image file or the edited output image file to print (S680). Whether the target frame is edited or not, the unedited image file or the edited output image file can be printed out by means of a printer through the image transmission standard called “PictBridge”.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system capable of capturing and printing a TV frame, comprising:
a tuner, for receiving a TV signal;
a processor coupled to the tuner, for processing the TV signal to generate the TV frame;
a first memory coupled to the processor, for storing the TV frame;
an image compression engine coupled to the processor and the first memory, wherein the processor controls the image compression engine to read a target frame from the first memory, and the image compression engine processes the target frame to generate an image file and stores the image file in the first memory;
a display unit coupled to the processor, for displaying the TV frame and the image file;
a first connecting interface;
an interface controller coupled to the processor and the first connecting interface, for controlling the first connecting interface; and
a printer coupled to the first connecting interface, for communicating with the processor through an image transmission standard to receive and print the image file.

2. The system of claim 1, wherein the image transmission standard is the DC-001-2003 Digital Photo Solutions for Imaging Devices published by Camera and Imaging Products Association (CIPA).

3. The system of claim 1, wherein the first connecting interface is a Universal Serial Bus (USB) interface.

4. The system of claim 1, further comprising:
a second connecting interface coupled to the interface controller, for connecting with a second memory, wherein the processor is capable of storing the image file in the second memory.

5. The system of claim 1, further comprising:
a control signal receiver coupled to the processor, for receiving a control signal from a remote controller and transmitting the control signal to the processor.

6. The system of claim 1, wherein the image compression engine is a JPEG engine.

7. A TV apparatus, comprising:
a tuner, for receiving a TV signal;
a processor coupled to the tuner, for processing the TV signal to generate a TV frame;
a display unit coupled to the processor, for displaying the TV frame;
a Universal Serial Bus (USB) interface supporting the DC-001-2003 Digital Photo Solutions for Imaging Devices published by Camera and Imaging Products Association (CIPA); and
an interface controller coupled to the processor and the USB interface, for controlling the USB interface.

8. The TV apparatus of claim 7, further comprising:
a memory coupled to the processor, for storing the TV frame.

9. The TV apparatus of claim 8, further comprising:
an image compression engine coupled to the processor and the memory, wherein the processor controls the image compression engine to read a target frame from the memory, and the image compression engine processes the target frame to generate an image file and stores the image file in the memory.

10. The TV apparatus of claim 9, wherein the image compression engine is a JPEG engine.

11. The TV apparatus of claim 7, further comprising:
a control signal receiver coupled to the processor, for receiving a control signal from a remote controller and transmitting the control signal to the processor.

12. A method for capturing and printing a TV frame, comprising:
receiving a TV signal;
processing the TV signal to generate the TV frame;
storing the TV frame in a memory;
processing a target frame read from the memory to generate an image file, and storing the image file in the memory; and
transmitting the image file to a printer through an image transmission standard to print the image file.

13. The method of claim 12, further comprising:
displaying the TV frame and the image file.

14. The method of claim 12, wherein the image transmission standard is the DC-001-2003 Digital Photo Solutions for Imaging Devices published by Camera and Imaging Products Association (CIPA).

15. The method of claim 12, further comprising:
editing the image file to generate an output image file to be stored in the memory.

16. The method of claim 15, further comprising:
transmitting the output image file to the printer through the image transmission standard to print the output image file.

17. The method of claim 12, wherein the TV signal is an analog signal.

18. The method of claim 17, further comprising: converting the analog signal into a digital signal.

19. A control circuit of a TV capable of capturing and printing a TV frame, comprising:
a processor for processing a TV signal to generate the TV frame;
an image compression engine coupled to the processor, wherein the processor controls the image compression engine to transform the TV frame into an image file; and
an interface controller coupled to the processor, for transmitting the image file through a connecting interface supporting Digital Photo Solutions for Imaging Devices.

20. The controlling circuit of claim 19, further comprising:
a memory coupled to the processor and the image compression engine, for storing the TV frame and the image file.

21. The controlling circuit of claim 19, wherein the connecting interface is a Universal Serial Bus (USB) interface.

22. The controlling circuit of claim 19, wherein the image compression engine is a JPEG engine.
